(19) United States
(12) Patent Application Publication
(10) Pub. No.: US 2012/0130716 A1
(43) Pub. Date: May 24, 2012

(54) SPEECH RECOGNITION METHOD FOR ROBOT

(75) Inventor: Ki Beom KIM, Seongnam-si (KR)

(73) Assignee: SAMSUNG ELECTRONICS CO., LTD., Suwon-si (KR)

(21) Appl. No.: 13/298,442

(22) Filed: Nov. 17, 2011

(30) Foreign Application Priority Data
Nov. 22, 2010 (KR) 10-2010-0116180

(51) Int. Cl. G10L 15/14; G10L 15/04

(52) U.S. Cl. 704/256.1; 704/251; 901/50; 704/E15.027

(57) ABSTRACT

A speech recognition method for a robot. The speech recognition method for the robot includes one fundamental acoustic model. Whenever the noisy environment and the speaker are changed, the speech recognition method generates a plurality of parallel acoustic models in which the characteristic for each noisy environment and the characteristic for each speaker are reflected. As a result, the speech recognition method for the robot can freely recognize one of several acoustic models according to individual environments and speakers, such that it can basically remove mismatch between the model training environment and the test environment, thereby improving speech recognition capabilities.

### CROSS-REFERENCE TO RELATED APPLICATIONS

This application claims the benefit of Korean Patent Application No. 2010-0116180, filed on Nov. 22, 2010 in the Korean Intellectual Property Office, the disclosure of which is incorporated herein by reference.

### BACKGROUND

1. Field

Embodiments relate to a speech recognition method for a robot that is capable of performing speech recognition irrespective of environment variation and variation of a speaker.

2. Description of the Related Art

In recent times, with the increasing development of robot technology, a variety of speech recognition algorithms have been widely applied to robot systems in order to enable humans to communicate with robots. Specifically, a robot which has to communicate with humans needs to analyze a voice signal of a user such that the robot can recognize who the user is and what the user is talking about on the basis of the analyzed result.

Recently, as consumer demand for speech recognition continues to rise, robot products each having a microphone for speech recognition have been widely developed.

The robot extracts unique characteristics of each sound by applying speech recognition technology to sound sources received through the microphone, performs correct modeling of the sound signal (i.e., voice signal) using the speech recognition technology, and discriminates characteristics of each sound, thereby recognizing speech content of a sound source.

For the widespread use of speech recognition technology, speech recognition performance should be guaranteed under a variety of environments. In order to guarantee speech recognition performance, a variety of technical problems should be addressed.

The primary reason for reduction in speech recognition rate is mismatch between one test environment in which the user talks about and a training environment used for acoustic modeling. Such mismatch may be caused by various interference signals added to an objective sound to be recognized and a speaker's voice signal not contained in the configured speech model. There are a variety of methods for removing the above-mentioned mismatch, for example, a speech enhancement method, a feature compensation method, and a model adaptation method. The speech enhancement method reduces noise components from an input voice signal so as to generate a signal having improved sound quality. The feature compensation method converts characteristics of an input voice having noise into other characteristics extracted from a clean voice. The model adaptation method performs conversion of the recognition model in the opposite way to the feature compensation method, such that the adapted model is learned from a voice signal having noise.

The speech recognition method using general model adaptation technology uses only one acoustic model constructed in the clean environment so as to remove the dependency of noisy environment. Conventional modeling techniques focus on how to construct only one acoustic model so as to increase recognition performance and recognition speed.

That is, the conventional speech recognition method aims to construct one acoustic model capable of properly coping with environmental variation and speaker variation.

Therefore, although the above-mentioned conventional speech recognition method is well matched to the final objective (i.e., Speaker Independent Large Vocabulary Continuous Speech Recognition) of speech recognition, the speech recognition performance of the conventional speech recognition method is unavoidably restricted.

The reason why the performance is restricted is that the conventional scheme performs adaptation of one model so as to implement generalized speaker adaptation and generalized noisy environment adaptation. The operation for applying one model to the arbitrary speaker's voice under an arbitrary environment cannot guarantee stable performance using conventional speech recognition technology.

### SUMMARY

Therefore, it is an aspect of an embodiment to provide a speech recognition method for a robot for use in a speech recognition apparatus of the robot capable of performing speech recognition using a model adaptation method. The speech recognition method for the robot generates an acoustic model in which characteristics of each noisy environment are reflected and the other acoustic model in which characteristics of each speaker are reflected on the basis of the fundamental acoustic model, thereby enhancing speech recognition capabilities by coping with environmental and speaker variation. As a result, the speech recognition method for the robot can recognize speech or voice using the generated acoustic models.

Additional aspects of embodiments will be set forth in part in the description which follows and, in part, will be obvious from the description, or may be learned by practice of the embodiments.

In accordance with an aspect of an embodiment, there is provided a speech recognition method for a robot including generating and storing an acoustic model adapted to noise for each noisy environment; generating and storing an acoustic model adapted to each speaker, receiving noise and a voice signal from a speech recognition environment, selecting a first acoustic model adapted to the received noise and a second acoustic model adapted to a speaker of the received voice signal; and performing speech recognition upon the received voice signal using the selected first and second acoustic models.

The generating and storing of the acoustic model adapted to the noise generate an acoustic model adapted to noise for each noisy environment using a Parallel Model Combination (PMC) scheme.

The generating and storing of the acoustic model adapted to the noise generate an acoustic model adapted to noise for each noisy environment using a Jacobian Adaptation (JA) method.

The generating and storing of the acoustic model adapted to each speaker generate the acoustic model adapted to each speaker using any one of a Hidden Markov Model (HMM) method, a Maximum A Posteriori (MAP) method, and a Maximum Likelihood Linear Regression (MLLR) method. When storing the acoustic model adapted to noise for each noisy environment, a tag in which a characteristic for each noisy environment is reflected is attached to the adapted acoustic model and then stored. When storing the acoustic model adapted to each speaker, a tag in which a characteristic for each speaker is reflected is attached to the acoustic model adapted to each speaker and then stored.

The selection of the first acoustic model adapted to the received noise and the second acoustic model adapted to the speaker of the received voice is carried out on the basis of the tag.

In accordance with another aspect of an embodiment, there is provided a speech recognition method for a robot including receiving noise and a voice signal from a speech recognition environment; determining whether the received noise is new noise, modifying a predetermined clean acoustic model in response to the new noise when the received noise is the new noise, and generating an acoustic model adapted to the new noise, after generating the acoustic model adapted to the new model, determining whether a speaker of the received voice signal is a registered speaker, modifying a predetermined clean acoustic model in response to the new speaker when the speaker of the received noise is an unregistered new speaker, and generating an acoustic model adapted to the new speaker, and storing the generated acoustic models.

The determining whether or not the received noise is new noise includes comparing statistical data related to the received noise with a pre-stored noise model, and determining whether the received noise is new noise according to the comparison result.

The determining whether the speaker of the received voice signal is the new speaker may include extracting a characteristic of the received voice signal, calculating similarity between the extracted characteristic and a pre-registered speaker model, and determining whether the speaker of the received voice signal is the new speaker on the basis of the calculated similarity.

The generating and storing of the acoustic model adapted to the new noise may generate an acoustic model adapted to the new noise using either one of a Parallel Model Combination (PMC) scheme and a Jacobian Adaptation (JA) method.

The generating and storing of the acoustic model adapted to the new speaker may generate the acoustic model adapted to the new speaker using any one of a Hidden Markov Model (HMM) method, a Maximum A Posteriori (MAP) method, and a Maximum Likelihood Linear Regression (MLLR) method.

According to the above-mentioned embodiments, the speech recognition method for the robot according to embodiments includes only one fundamental acoustic model and a plurality of parallel acoustic models in which the characteristic for each noisy environment and the characteristic for each speaker are reflected, whereas the conventional art performs speech recognition using only one acoustic model. As a result, the speech recognition method for the robot can freely recognize one of several models according to individual environments and speakers, and can basically remove the mismatch between the model training environment and the test environment, thereby increasing the speech recognition capability.

### BRIEF DESCRIPTION OF THE DRAWINGS

These and/or other aspects of embodiments will become apparent and more readily appreciated from the following description of the embodiments, taken in conjunction with the accompanying drawings of which:

FIG. 1 is a configuration diagram illustrating a speech recognition apparatus for a robot according to an embodiment.

FIG. 2 is a control block diagram illustrating a speech recognition apparatus for a robot according to an embodiment.

FIG. 3 is a flowchart illustrating a method for performing model adaptation to noisy environment using a speech recognition apparatus for a robot according to an embodiment.

FIG. 4 is a configuration diagram illustrating a model structure obtained after model adaptation is applied to a noisy environment in the speech recognition apparatus of the robot according to an embodiment.

FIG. 5 is a flowchart illustrating a method for performing model adaptation to a speaker using the speech recognition apparatus of the robot according to an embodiment.

FIG. 6 is a configuration diagram illustrating a model structure obtained after model adaptation is applied to the speaker in the speech recognition apparatus of the robot according to an embodiment.

FIG. 7 is a flowchart illustrating a method for controlling the speech recognition apparatus of the robot according to an embodiment.

### DETAILED DESCRIPTION

Reference will now be made in detail to the embodiments, examples of which are illustrated in the accompanying drawings, wherein like reference numerals refer to like elements throughout.

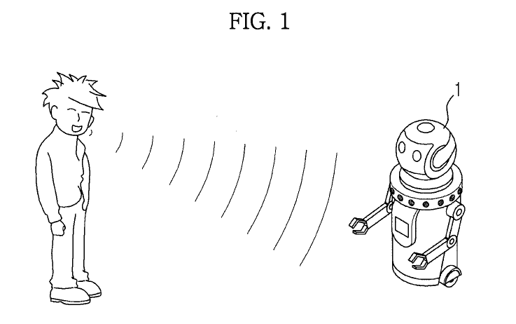

FIG. 1 is a configuration diagram illustrating a speech recognition apparatus for a robot according to an embodiment.

Referring to FIG. 1, the speech recognition apparatus for the robot according to an embodiment includes a microphone. If the speech recognition apparatus receives a voice signal from a speaking user of a transmitter of the speech recognition apparatus of the robot, and the voice signal indicates a new noisy environment and a speaker using the model adaptation method, the speech recognition apparatus for the robot recognizes the speaker's voice by executing noisy environment adaptation and speaker adaptation.

The speech recognition apparatus for the robot generates/stores the acoustic model adapted to noise for each noisy environment, generates/stores the acoustic model adapted to each speaker, receives a noisy voice signal and a speaker's voice signal under the speech recognition environment, selects not only one acoustic model adapted to noise corresponding to the input noisy voice signal and the speaker's voice signal, but also another acoustic model adapted to the speaker, and performs speech recognition using the acoustic model adapted to the selected noise and the acoustic model adapted to the speaker.

Generally, the environment and the speaker have a limited application range, such that it is necessary to restrict the assumption in which the speech recognition apparatus for the robot covers an arbitrary environment and an arbitrary speaker. Since one model has difficulty in properly coping with the arbitrary speaker and the arbitrary environment, the number of speakers and the number of environments should be restricted and several models adapted for the restricted speakers and environments should be compatible with each other, so as to achieve a system appropriate for real world scenarios.

The model according to an embodiment can be broadly classified into two parts, i.e., model adaptation for environment and model adaptation for speaker.

The model adaptation for noisy environment checks the type of ambient noise of an environment used for speech recognition, and stores the checked result, such that it can properly cope with variation of the peripheral environment.

The speaker model adaptation checks and stores the type of a talking user, such that it can properly cope with variation in user speech. The model can be tone of two types, i.e., an environment-type model and a speaker-type model. A clean acoustic model for each variation is properly modified such that a speech recognizer having strong resistance to environmental variation and speaker variation can be configured. The acoustic model is a basic statistical model constructing the recognition network, and is modeled according to a mean value and a dispersion value for each phoneme.

The clean acoustic model is a source for model adaptation, such that models to be adapted are configured to copy and use this clean acoustic model. The model space to be newly adapted is classified according to individual environments such that individual elements construct a two-dimensional model matrix and therefore model adaptation for noisy environments and model adaptation for the speaker are carried out.

The conventional robot speech recognition apparatus includes only one clean acoustic model. In addition, although the conventional robot speech recognition apparatus satisfies the model adaptation method, it can use only one modified model. In contrast, the inventive robot speech recognition apparatus according to an embodiment includes one simple acoustic model, attaches a tag in which the characteristic for each noisy environment and the characteristic for each speaker are reflected to the acoustic model, such that it includes a plurality of parallel acoustic models that have been adapted to environmental variation and speaker variation.

In other words, the robot speech recognition apparatus can achieve improved flexibility and accuracy, and mismatch between the model training environment and the test environment is removed, such that the robot speech recognition apparatus according to an embodiment can provide a solution to the pre-processing problem encountered in speech recognition. Because of the flexibility and the accuracy, the robot speech recognition apparatus can freely select one of several models according to environment and speaker, and then recognizes the selected one.

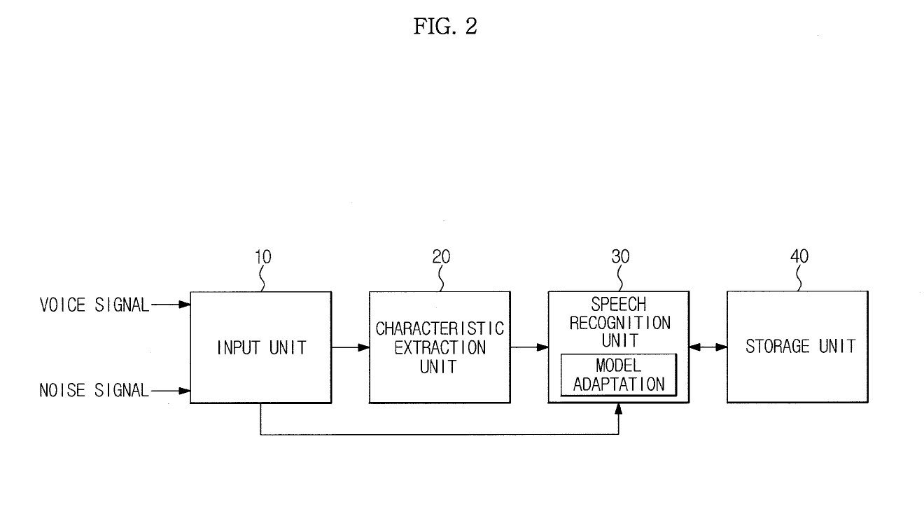

FIG. 2 is a control block diagram illustrating a speech recognition apparatus for a robot according to an embodiment.

Referring to FIG. 2, the robot speech recognition apparatus 1 receives a voice signal (or a speech signal) as an input, and extracts characteristics appropriate for the speech recognition from the received voice signal, thereby recognizing the received voice signal using the extracted result.

For the above-mentioned operation, the robot speech recognition apparatus includes an input unit 10, a characteristic extraction unit 20, a speech recognition unit 30, and a storage unit 40.

The input unit 10 receives a voice signal through a microphone, and transmits the received voice signal to the characteristic extraction unit 20.

In addition, the input unit 10 receives the voice signal through the microphone as an input and directly transmits the received voice signal to the speech recognition unit 30.

The input unit 10 receives a noise signal through the microphone as an input and directly transmits the noise signal to the speech recognition unit 30.

The characteristic extraction unit 20 extracts the characteristic part from the voice signal received through the input unit 10. For example, voice data is divided into several parts according to individual frames, the characteristic extraction unit 20 extracts the characteristic part of the voice signal using a Mel-Frequency Cepstrum Coefficient (MFCC) method to calculate a Cepstrum Coefficient corresponding to each frame so as to extract the characteristics of the voice signal.

The speech recognition unit 30 applies the model adaptation method to the voice signal characteristic extracted by the characteristic extraction unit 20, the voice signal directly received through the input unit and/or the noise signal, such that it can perform speech recognition on the basis of the application result. For example, the speech recognition unit 30 receives the characteristics extracted from the noisy voice signal without change. Via the model adaptation, the pre-stored clean acoustic model is adapted to the noisy voice signal, thereby achieving speech recognition.

In addition, whenever new noise and new speaker's voice signal are input under the speech recognition environment, the speech recognition unit 30 generates and stores the acoustic model adapted to noise for each noisy environment, and generates and stores the acoustic model adapted to each speaker.

Under this condition, if old noise and the speaker's voice signal are input to the speech recognition unit 30, the speech recognition unit 30 selects not only one acoustic model adapted to noise corresponding to the input noisy voice signal, but also another acoustic model adapted to noise corresponding to the speaker's voice signal, and thus performs speech recognition using the selected acoustic models.

Differently from the characteristic compensation method, the model adaptation method enables the recognition model to be adapted to noisy situations without correcting the input characteristics. Presently, most speech recognition systems use the Hidden Markov Model (HMM). The HMM can be trained and built using a large number of noise-free voice signals.

Therefore, the model adaptation method is designed to learn the HMM from the noisy voice signal. The model adaptation method is derived from various methods for speaker adaptation. Representative examples of the model adaptation method are Maximum A Posteriori (MAP) method and a Maximum Likelihood Linear Regression (MLLR) method. The MAP method performs interpolation of the recognition model obtained through adaptation data and the pre-recognized model. The MLLR method adds a matrix obtained from adaptation data to each recognition model, and performs data conversion using the matrix.

Besides the above-mentioned two methods for speaker adaptation, representative examples of the model adaptation method widely used in the noisy environment are a Parallel Model Combination (PMC) method and a Jacobian Adaptation (JA) method for greatly reducing the number of calculations. The PMC method represents a clean voice signal and noise using different HMMs, and combines the two models with each other, thereby generating a model having a noisy voice signal. Although the PMC-based model adaptation method has superior performance, it has to perform too many calculations because of the calculations of the log and exponential functions. The method for effectively reducing the number of calculations of the PMC method is to linearly approximate a non-linear function used in PMC, and is called the JA method.

The storage unit 40 stores fundamental acoustic model information, acoustic model information adapted to noise for each noisy environment, acoustic model information adapted to each speaker, and the like.

<Model Adaptation for Noisy Environment>

If the speech recognition unit 30 receives ambient noise from the microphone before the user speaks, it stores a pattern including a mean value and a dispersion value of the initial input noise. If the ambient noise is changed because of environmental changes and the input of new noise, a statistical value of the changed noisy environment is compared with that of the pre-stored noise model. If the statistical value of the changed noisy environment is different from that of the pre-stored noise model, the speech recognition unit 30 generates not only the legacy clean model but also a new acoustic model adapted to noise.

In various embodiments, input unit 10, characteristic extraction unit 20, speech recognition unit 30 and storage unit 40 are included in a robot so that their operations are performed by the robot.

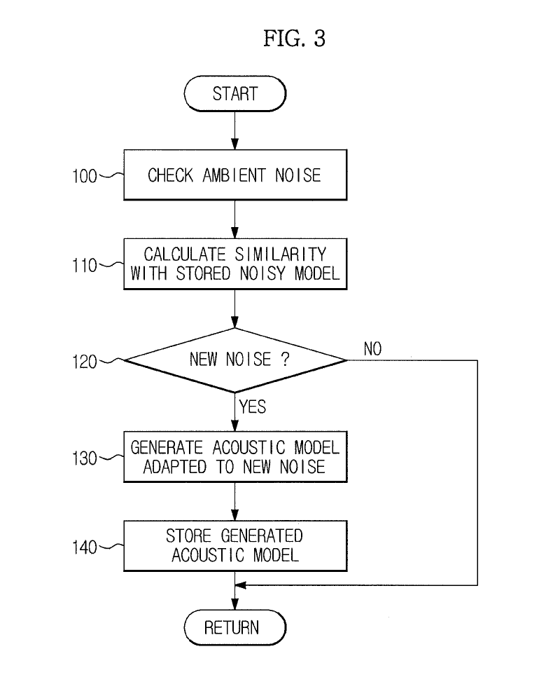

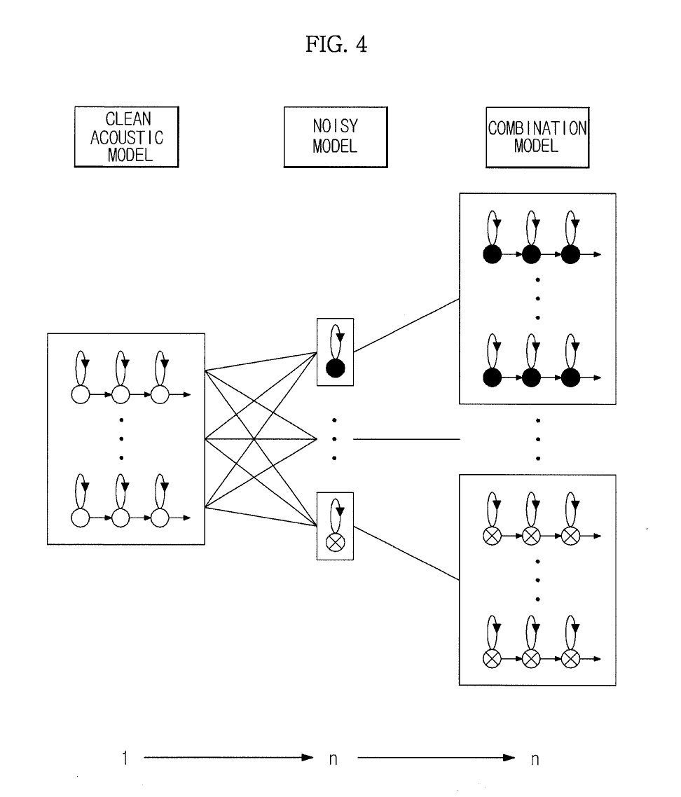

FIG. 3 is a flowchart illustrating a method for performing model adaptation to noisy environments using a speech recognition apparatus for a robot according to an embodiment. FIG. 4 is a configuration diagram illustrating a model structure obtained after model adaptation is applied to the noisy environment in the speech recognition apparatus of the robot according to an embodiment.

Referring to FIG. 3, the speech recognition unit 30 checks the ambient noise received through the input unit 10 before the user speaks at operation 100.

The speech recognition unit 30 compares the statistical value for the checked ambient noise with the pre-stored noise model, such that it calculates similarity between the checked ambient noise and the pre-stored noise model at operation 110.

After calculating the similarity between the checked ambient noise and the pre-stored noise model, the speech recognition unit 30 determines whether the checked ambient noise is new noise according to the similarity calculation result at operation 120.

If the calculated similarity is equal to or less than a predetermined value, the speech recognition unit 30 determines that the checked ambient noise is not new noise, and returns to the predetermined routine for completing the control.

In the meantime, if the calculated similarity is higher than the predetermined value, the speech recognition unit 30 determines that the checked ambient noise is the new noise, and generates an acoustic model adapted to the new noise at operation 130.

After generating the acoustic model in which adaptation to new noise is achieved, the speech recognition unit 30 stores the acoustic model adapted to new noise in the storage unit 40 at operation 140. Thereafter, the speech recognition unit 30 returns to the predetermined routine.

Whenever noisy environment is newly changed, the conventional clean acoustic model and the acoustic model adapted to each noise are respectively generated and stored.

In other words, if an input signal is adapted to N different environments, one model is assigned to and generated for each environment, such that N acoustic models are generated (See FIG. 4).

Referring to FIG. 4, an acoustic model adapted to a new noisy environment is generated by combining the clean acoustic model with the new noise using the PMC method. That is, the clean acoustic model is modified according to new noise using the PMC method, and the modified acoustic model is adapted to the environmental change, such that the acoustic model adapted to new noise is generated.

<Model Adaptation for Speaker>

The model adaptation technology for the noisy environment from among various model adaptation methods of the speech recognition unit 30 generates an acoustic model capable of coping with the speaker variation.

The speech recognition unit 30 stores statistic data of new speaker's voice signals in the storage unit 40. If it is assumed that the general speaker verification technology can basically recognize who the speaker is and can also basically recognize whether the speaker is a pre-registered speaker or a non-registered speaker, the model adaptation technology for the speaker can further cover even the speaker adaptation. That is, the speech recognition unit 30 calculates the similarity between the current speaker's voice and the pre-registered speaker model. If the talking user is determined to be a new speaker, the speech recognition unit 30 performs the speaker adaptation.

The speaker adaptation performs transcription of the clean acoustic model, performs phoneme matching in relation to the conventional model, and changes a phoneme value dependent upon the speaker, thereby constructing a new speaker model. If the pre-stored speaker model is determined, speaker adaptation is not performed.

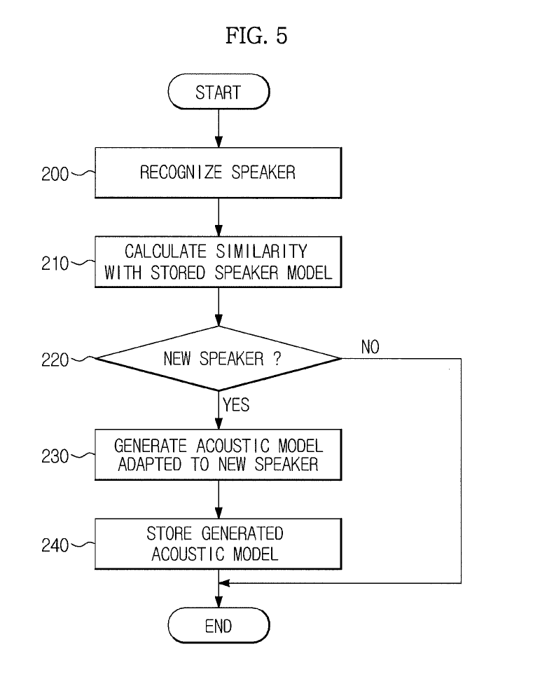

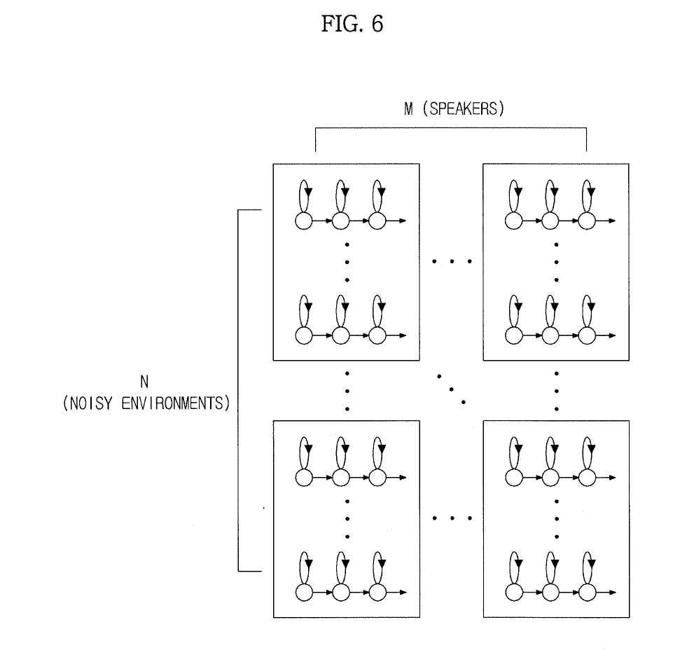

FIG. 5 is a flowchart illustrating a method for performing model adaptation to a speaker using the speech recognition apparatus of the robot according to an embodiment. FIG. 6 is a configuration diagram illustrating a model obtained after model adaptation is applied to the speaker in the speech recognition apparatus of the robot according to an embodiment.

Referring to FIG. 5, the speech recognition unit 30 recognizes who the speaker is at operation 200.

After recognizing who the speaker is, the speech recognition unit 30 compares statistical values related to the speaker with a pre-stored speaker model, and calculates the similarity between the recognized speaker and the pre-registered speaker model at operation 210.

After calculating the similarity between the recognized speaker and the recognized speaker model, the speech recognition unit 30 determines whether the recognized speaker is a new speaker who is not registered according to the similarity calculation result at operation 220.

If the calculated similarity is equal to or less than a predetermined value, the speech recognition unit 30 determines that the recognized speaker is not a new speaker, and returns to a predetermined routine for completing the control.

In the meantime, if the calculated similarity is higher than the predetermined value, the speech recognition unit 30 determines that the recognized speaker is a new speaker, and generates an acoustic model adapted to the new speaker at operation 230.

After generating the acoustic model adapted to the new speaker, the speech recognition unit 30 stores the acoustic model in the storage unit 40 at operation 240. Thereafter, the speech recognition unit 30 returns to the predetermined routine.

Whenever a new speaker appears, the conventional clean acoustic model and the acoustic model adapted to each speaker are respectively generated and stored.

If the speech recognition unit 30 performs the model adaptation for the noisy environment and the model adaptation for the speaker, the acoustic model generates (m×n) model spaces for N environments and M speakers (See FIG. 6).

Therefore, whenever the speech recognition apparatus for the robot is driven, the model adaptation for noisy environments and the model adaptation for speakers are carried out and the most similar acoustic model for each speaker is selected, such that the voice signal can be more effectively recognized.

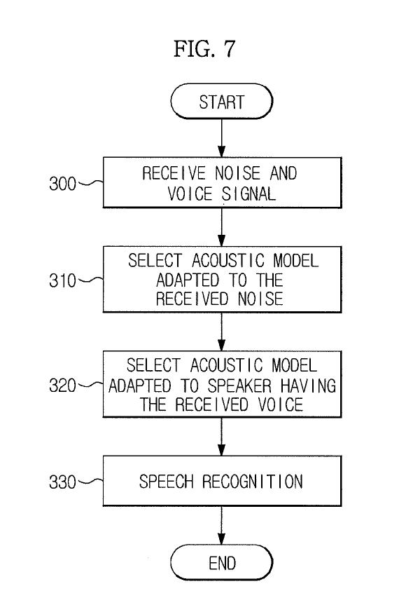

FIG. 7 is a flowchart illustrating a method for controlling the speech recognition apparatus of the robot according to an embodiment.

Referring to FIG. 7, the speech recognition unit 30 receives noise and a voice signal at operation 300.

Upon receiving the noise and the voice signal, the speech recognition unit 30 selects the acoustic model adapted to the received noise at operation 310.

In addition, the speech recognition unit 30 selects the acoustic model adapted to the speaker of the received voice signal at operation 320.

In operation 330, the speech recognition unit 30 performs speech recognition upon the received voice signal using the acoustic model adapted to the noise selected at operation 310 and the other acoustic model adapted to the speaker having the voice signal selected at operation 320.

As is apparent from the above description, the speech recognition method for the robot according to embodiments extends one acoustic model to a two-dimensional model space distinguished by the environment variation and the speaker variation. The speech recognition method adds a new acoustic model in response to environmental variation and speaker variation, such that it can implement more robust performance although the input voice signal does not match that of the legacy model. As a result, the speech recognition method for the robot can freely recognize one of several models according to individual environments and speakers due to such flexibility and robustness, and can basically eliminate mismatch between the model training environment and the test environment, thereby obviating the pre-processing problem encountered in speech recognition.

According to embodiments, a method includes: (a) generating and storing a plurality of acoustic models adapted to noise for a plurality of noisy environments, respectively; (b) generating and storing a plurality of acoustic models adapted to a plurality of speakers, respectively; (c) receiving noise and a voice signal; (d) selecting a first acoustic model adapted to the received noise from the generated and stored plurality of acoustic models adapted to noise for the plurality of noisy environments and a second acoustic model adapted to a speaker of the received voice signal from the generated and stored plurality of acoustic models adapted to the plurality of speakers; and (e) performing, by a computer, speech recognition upon the received voice signal using the selected first and second acoustic models.

Moreover, according to embodiments, a method includes (a) generating a plurality of acoustic models adapted to noise for a plurality of noisy environments, respectively, of a robot; (b) generating a plurality of acoustic models adapted to a plurality of speakers to the robot, respectively; (c) receiving, by the robot, noise from a respective environment in which the robot currently exists and a voice signal from a speaker in the environment in which the robot currently exists; (d) selecting, by the robot, a first acoustic model adapted to the received noise from the generated plurality of acoustic models adapted to noise for the plurality of noisy environments and a second acoustic model adapted to the speaker of the received voice signal from the generated plurality of acoustic models adapted to the plurality of speakers; and (e) performing, by the robot, speech recognition upon the received voice signal using the selected first and second acoustic models.

Embodiments can be implemented in computing hardware and/or software, such as (in a non-limiting example) any computer that can store, retrieve, process and/or output data and/or communicate with other computers. For example, characteristic extraction unit 20 and speech recognition unit 30 in FIG. 2 may include a computer to perform computations and/or process described herein. A program/software implementing embodiments may be recorded on non-transitory computer-readable media comprising computer-readable recording media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Embodiments are described herein as relating to speech recognition for use by a robot. However, the embodiments are not limited to use by a robot and, instead, are applicable to speech recognition by other apparatuses.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A method comprising:
generating and storing a plurality of acoustic models adapted to noise for a plurality of noisy environments, respectively;
generating and storing a plurality of acoustic models adapted to a plurality of speakers, respectively;
receiving noise and a voice signal;
selecting a first acoustic model adapted to the received noise from the generated and stored plurality of acoustic models adapted to noise for the plurality of noisy environments and a second acoustic model adapted to a speaker of the received voice signal from the generated and stored plurality of acoustic models adapted to the plurality of speakers; and
performing, by a computer, speech recognition upon the received voice signal using the selected first and second acoustic models.

2. The method according to claim 1, wherein the generating of the plurality of acoustic models adapted to the noise for the plurality of noisy environments includes generating an acoustic model adapted to noise for each of the plurality of noisy environments using a Parallel Model Combination (PMC) scheme.

3. The method according to claim 1, wherein the generating of the plurality of acoustic models adapted to noise for the plurality of noisy environments includes generating an acoustic model adapted to noise for each of the plurality of noisy environments using a Jacobian Adaptation (JA) method.

4. The method according to claim 1, wherein the generating of the plurality of acoustic models adapted to a plurality of speakers includes generating the plurality of acoustic models adapted to the plurality of speakers using any one of a Hidden Markov Model (HMM) method, a Maximum A Posteriori (MAP) method, and a Maximum Likelihood Linear Regression (MLLR) method.

5. The method according to claim 1, wherein:
when storing the plurality of acoustic models adapted to noise for the plurality of noisy environments, a tag in which a characteristic for each noisy environment is reflected is attached to the adapted acoustic model for the respective noisy environment and then stored; and
when storing the plurality of acoustic models adapted to the plurality of speakers, a tag in which a characteristic for each speaker is reflected is attached to the acoustic model adapted to the respective speaker and then stored.

6. The method according to claim 5, wherein the selection of the first acoustic model and the second acoustic model is carried out on the basis of the tags.

7. The method according to claim 1, wherein the plurality of noisy environments are noisy environments of a robot, and the plurality of speakers are speakers that speak to the robot.

8. A method comprising:
receiving noise and a voice signal;
determining whether the received noise is new noise;
modifying, by a computer, a predetermined clean acoustic model in response to the new noise when it is determined that the received noise is new noise, and generating an acoustic model adapted to the new noise;
after generating the acoustic model adapted to the new noise, determining whether a speaker of the received voice signal is a registered speaker;
modifying, by a computer, a predetermined clean acoustic model in response to the speaker of the received voice signal when it is determined that the speaker of the received noise is not a registered speaker and is thereby a new speaker, and generating an acoustic model adapted to the new speaker; and
storing the generated acoustic model adapted to the new noise and the generated acoustic model adapted to the new speaker.

9. The method according to claim 8, wherein the determining whether the received noise is new noise includes:
comparing statistical data related to the received noise with a pre-stored noise model, and determining whether the received noise is new noise according to a result of said comparing.

10. The method according to claim 8, wherein the determining whether the speaker of the received voice signal is a registered speaker includes:
extracting a characteristic of the received voice signal;
calculating similarity between the extracted characteristic and a pre-registered speaker model; and
determining whether the speaker of the received voice signal is a registered speaker on the basis of the calculated similarity.

11. The method according to claim 8, wherein the generating the acoustic model adapted to the new noise includes generating an acoustic model adapted to the new noise using either one of a Parallel Model Combination (PMC) scheme and a Jacobian Adaptation (JA) method.

12. The method according to claim 8, wherein the generating the acoustic model adapted to the new speaker includes generating the acoustic model adapted to the new speaker using any one of a Hidden Markov Model (HMM) method, a Maximum A Posteriori (MAP) method, and a Maximum Likelihood Linear Regression (MLLR) method.

13. The method according to claim 8, wherein the new noise is in an environment of a robot, and the speaker speaks to the robot.

14. A method comprising:
generating a plurality of acoustic models adapted to noise for a plurality of noisy environments, respectively, of a robot;
generating a plurality of acoustic models adapted to a plurality of speakers to the robot, respectively;
receiving, by the robot, noise from a respective environment in which the robot currently exists and a voice signal from a speaker in the environment in which the robot currently exists;
selecting, by the robot, a first acoustic model adapted to the received noise from the generated plurality of acoustic models adapted to noise for the plurality of noisy environments and a second acoustic model adapted to the speaker of the received voice signal from the generated plurality of acoustic models adapted to the plurality of speakers; and
performing, by the robot, speech recognition upon the received voice signal using the selected first and second acoustic models.
